(19) United States
(12) Patent Application Publication
(10) Pub. No.: US 2026/0078862 A1
(43) Pub. Date: Mar. 19, 2026

(54) ADJUSTABLE PEDESTAL SYSTEM FOR LEVEL SURFACES

(71) Applicant: UNILOCK CHICAGO, INC., Aurora, IL (US)

(72) Inventor: Rodney J DOMBROWSKI, Weston, WI (US)

(21) Appl. No.: 19/325,819

(22) Filed: Sep. 11, 2025

Related U.S. Application Data
(60) Provisional application No. 63/696,236, filed on Sep. 18, 2024.

(51) Int. Cl. F16M 7/00; F16M 11/24

(52) U.S. Cl. CPC F16M 7/00; F16M 11/24

(57) ABSTRACT

An adjustable pedestal system for level surfaces designed for accommodating variations in slope during installation. The adjustable pedestal system for level surfaces includes a base member having a bottom surface and top surface with a convex dome member formed thereon. A flexible, adjustable core member having a top end and a bottom surface having a concave recess may be adapted to friction fit with the top surface of the convex dome of the base member. A securement assembly may be adapted to secure the base member to the flexible, adjustable core member in a position. A top member having a top surface may be adapted to receive and maintain level surfaces, and a bottom surface may be adapted to securely engage the flexible, adjustable core member, whereby the bottom surface of the base member engages a non-leveled surface, and the bottom surface of the flexible, adjustable core member may articulate the flexible, adjustable core member relative to the top surface of the convex dome of the base member. This may accommodate the non-leveled surface and maintaining level surfaces on the top member. The versatility of the system facilitates easy installation, slope adjustment, and stability in varied roofing applications.

### BACKGROUND OF THE INVENTION

The construction and renovation of building exteriors, particularly rooftop decks, presents numerous challenges. Traditionally, building rooftop decks involved constructing supports and frameworks that were difficult to align and level, particularly on rooftops with uneven surfaces or varying slopes. Many existing deck pedestal systems offer limited adjustability, making it time-consuming and difficult for installers to achieve a level deck surface. This issue becomes more pronounced in applications with significant architectural variances or when retrofitting decks onto older buildings with irregular roofing structures.

In areas prone to severe weather, especially wind uplift, securing roof deck surface materials has also been problematic. Ensuring that decks remain stable and safe during extreme conditions is of paramount importance to developers and property owners alike.

Recognizing these challenges, the instant invention of an adjustable pedestal system for level surfaces was conceived to offer a more versatile and robust solution. Many pedestal systems do not allow for adjustable solutions that interface between the base and core units. Therefore, it is difficult to have adjustable angular alignment and the ability to compensate for varying slopes with ease. This is a key feature in a pedestal system as it enables for quicker installations and ensures level surfaces regardless of the underlying rooftop variations.

Traditional smooth-surface pedestals may not provide sufficient friction between components, which can lead to movement or slippage. As such having a surface that grips and enhances frictional engagement with the various components of the pedestal system may lead to greater overall stability of the rooftop deck structure.

Furthermore, given that high winds can displace the surface materials of rooftop decks, having the ability to secure the pedestal system in a lockdown bar configuration would be advantageous and serve as an additional safeguard against wind uplift. This ancillary component is critical for installations in geographies with high wind occurrences.

Sound absorption properties and friction are also critical aspects in a pedestal system as they may address noise pollution and the need for lateral movement resistance. These features are particularly important for residential buildings or spaces where excessive noise or material shifting is undesirable.

Given the uniqueness of the environment many pedestal systems are placed, customization of a pedestal system may also be important. Therefore, the ability to have customizable configurations catered to varying height requirements and space layouts between roof deck surface materials would be beneficial.

Finally having a pedestal system that is compatible with a range of roofing surfaces and materials, making it an excellent option for both new constructions and retrofit projects and able to work seamlessly with current systems would be advantageous.

This adjustable pedestal system for level surfaces therefore represents a significant step forward in the design of rooftop deck supports, offering builders and architects a more adaptable, secure, and user-friendly alternative to previous technologies.

### SUMMARY OF THE INVENTION

The present first embodiment provides an adjustable pedestal system for level surfaces designed to facilitate the installation of surface materials in a level manner on varying slopes. The adjustable pedestal system for level surfaces includes a base member having a bottom surface and top surface with a convex dome member formed thereon. A flexible, adjustable core member having a top end and a bottom surface having a concave recess may be adapted to friction fit with the top surface of the convex dome of the base member.

A securement assembly may be adapted to secure the base member to the flexible, adjustable core member in a position. A top member having a top surface may be adapted to receive and maintain level surfaces, and a bottom surface may be adapted to securely engage the flexible, adjustable core member, whereby the bottom surface of the base member engages a non-leveled surface, and the bottom surface of the flexible, adjustable core member may articulate the flexible, adjustable core member relative to the top surface of the convex dome of the base member. This may accommodate the non-leveled surface and maintaining level surfaces on the top member.

The concave recess of the bottom surface of the flexible, adjustable core member may further comprise of an enhanced coarse surface for increased friction fit of the convex dome of the base member to the flexible, adjustable core member.

In an alternative embodiment the adjustable pedestal system for level surfaces may further include a restraining means that may have a top side with a centered, threaded engagement aperture and a bottom side. The top member may have a top surface adapted to receive the restraining means and maintain level surfaces, and a bottom surface adapted to accept the restraining means and adapted to securely engage the flexible, adjustable core member. Finally, the adjustable pedestal system for level surfaces may include a locking means for securing the top member to the restraining means.

Additionally, the bottom surface of the base member may engage a non-leveled surface, and the bottom surface of the flexible, adjustable core member may articulate the flexible, adjustable core member relative to the top surface of the convex dome of the base member thereby accommodating the non-leveled surface and maintaining level surfaces on the top member.

Optional stackers are available as adjustable height units with integral vertical spacers for height adjustments and wind uplift considerations. The innovative design permits easy adaptation to various roof deck slopes and offers a secure, well-spaced, and sound-absorbing platform for roof deck construction.

### BRIEF DESCRIPTION OF DRAWINGS

FIG. 1 shows the adjustable pedestal system for level surfaces in an exploded perspective view of a preferred embodiment.

FIG. 2 shows the adjustable pedestal system for level surfaces in an exploded side view of the embodiment of FIG. 1.

FIG. 3 shows the adjustable pedestal system for level surfaces in a top perspective view of the embodiment of FIG. 1.

FIG. 4 shows the adjustable pedestal system for level surfaces in a bottom perspective view of the embodiment of FIG. 1.

FIG. 5 shows the top surface of the pedestal base member of the embodiment of FIG. 1.

FIG. 6 shows the top surface of the pedestal base member of the embodiment of FIG. 1.

FIG. 7 shows the top end of the flexible, adjustable core member of the embodiment of FIG. 1.

FIG. 8 shows the bottom surface of the flexible, adjustable core member of the embodiment of FIG. 1.

FIG. 9a shows the top surface of the securement assembly of the embodiment of FIG. 1.

FIG. 9b shows the bottom surface of the securement assembly of the embodiment of FIG. 1.

FIG. 10 shows the top surface of the top member of the embodiment of FIG. 1.

FIG. 11 shows the bottom surface of the top member of the embodiment of FIG. 1.

FIG. 12 shows the adjustable pedestal system for level surfaces in an exploded perspective view of a second preferred embodiment.

FIG. 13 shows the adjustable pedestal system for level surfaces in an exploded side view of the embodiment of FIG. 12.

FIG. 14a shows the top surface of the restraining means of the embodiment of FIG. 12.

FIG. 14b shows the bottom surface of the restraining means of the embodiment of FIG. 12.

FIG. 15 shows the adjustable pedestal system for level surfaces with additional adjustable flexible, adjustable core member in a top perspective view of FIG. 12.

FIG. 16 shows the locking means in a top perspective view.

FIG. 17 shows the adjustable pedestal system for level surfaces installed on a slope in a side cross-sectional view of FIG. 12.

### DETAILED DESCRIPTION OF THE INVENTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

This invention now will be described more fully hereinafter with reference to the accompanying drawings, in which exemplary embodiments are shown. Various embodiments are now described with reference to the drawings, wherein such as reference numerals are used to refer to such as elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

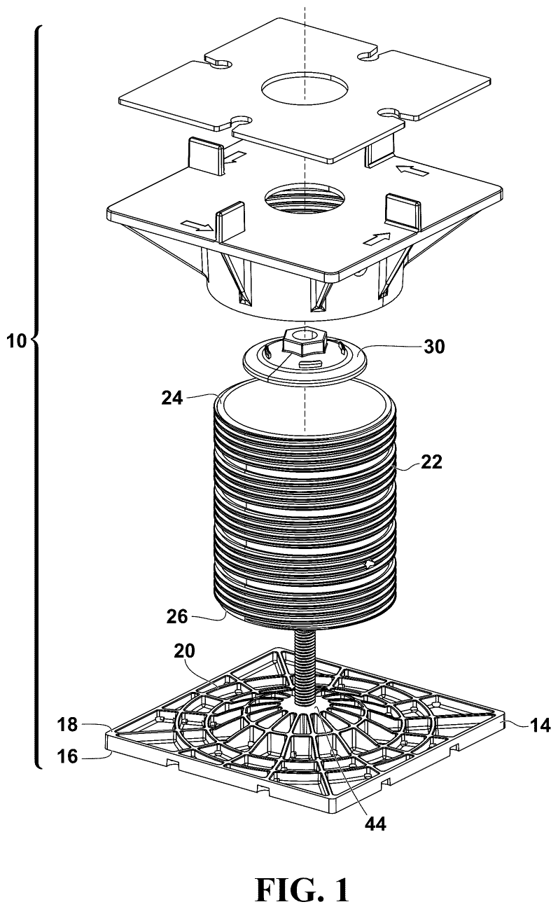

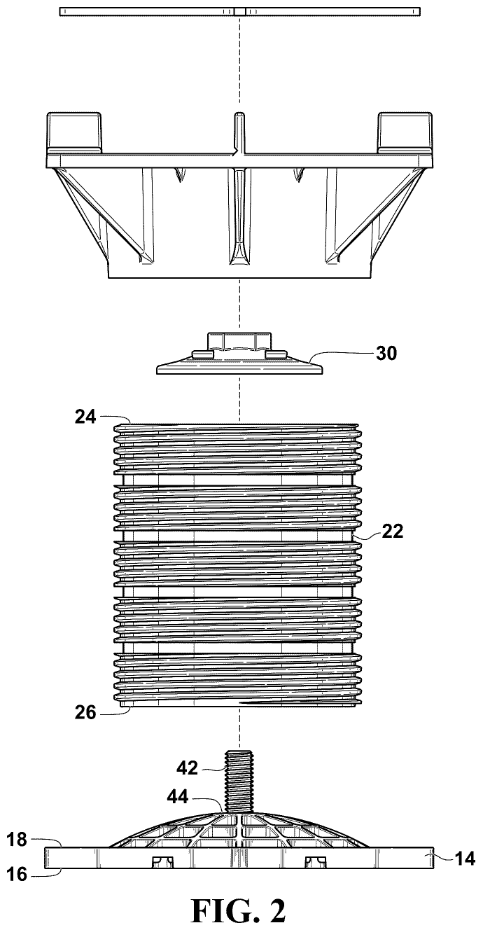

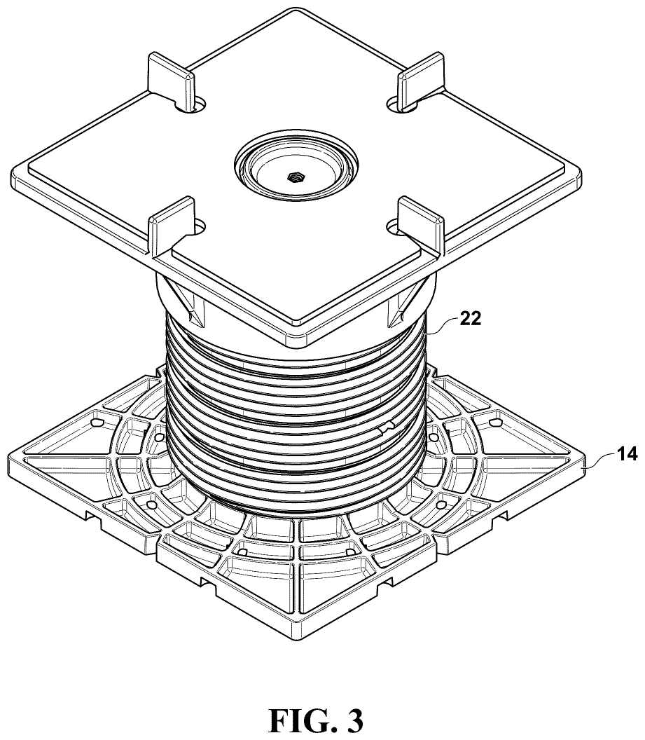

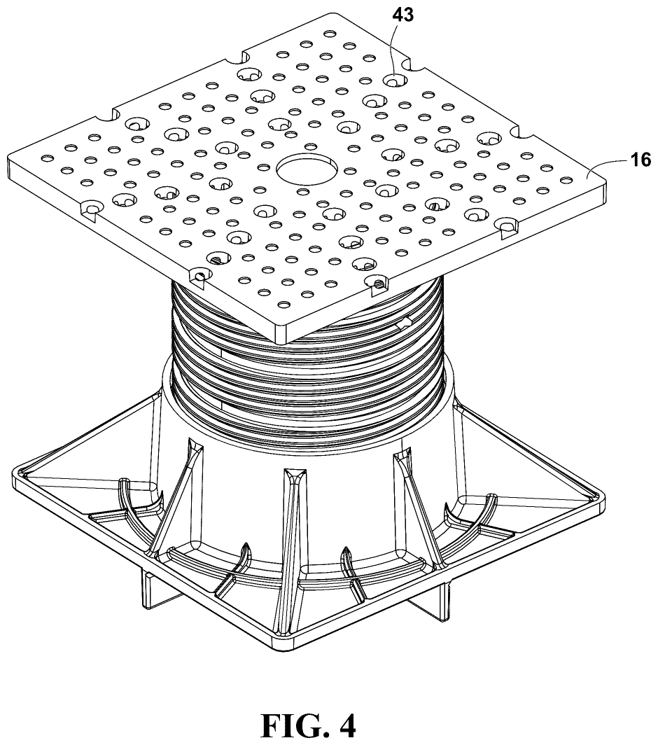

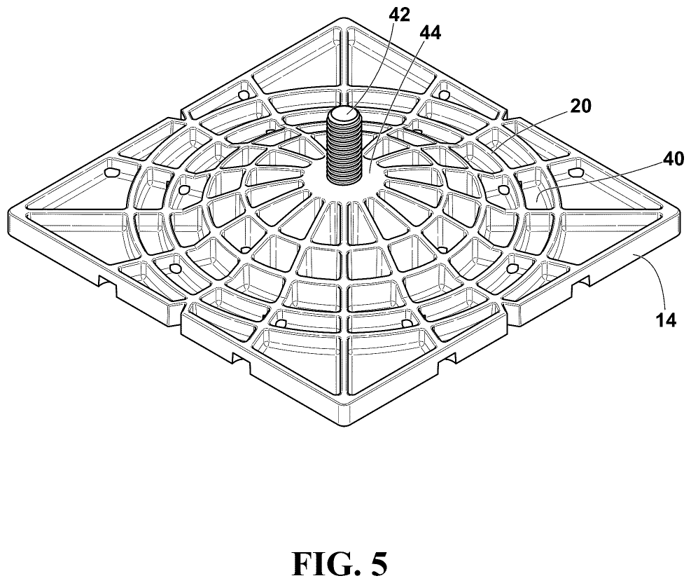

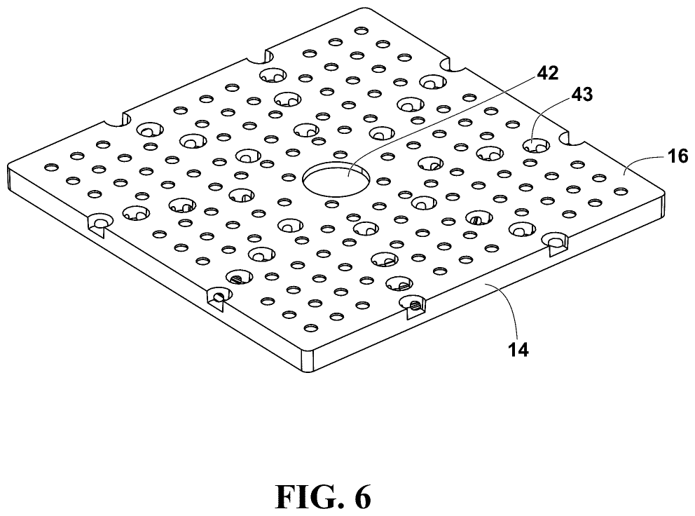

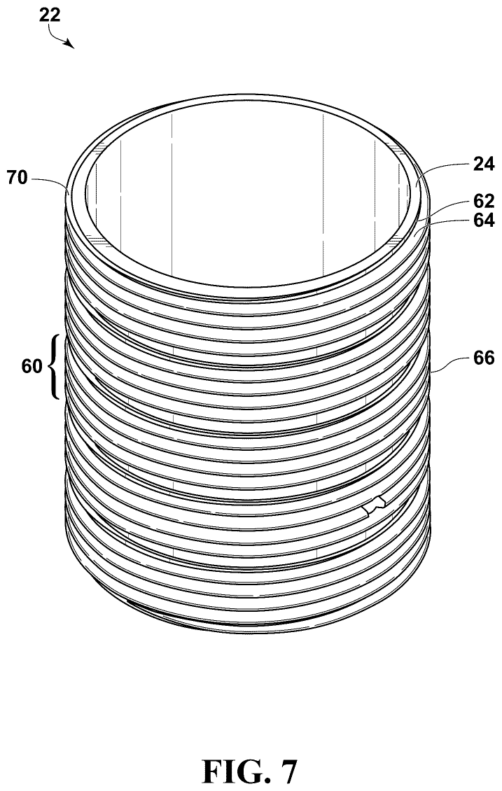

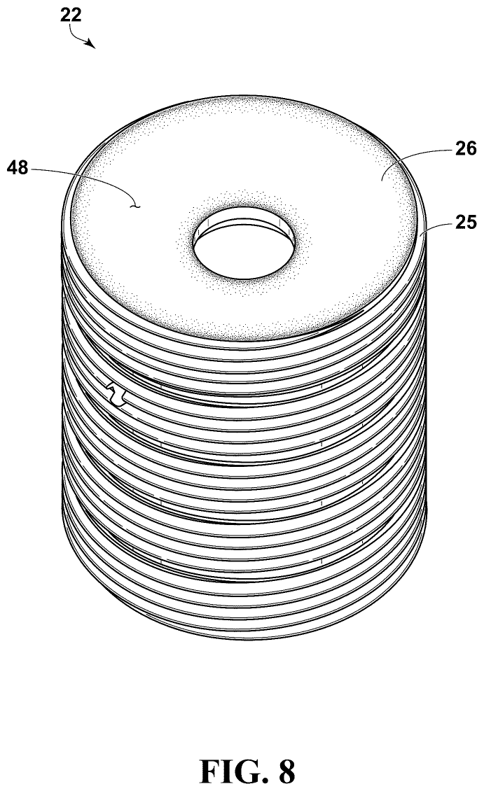

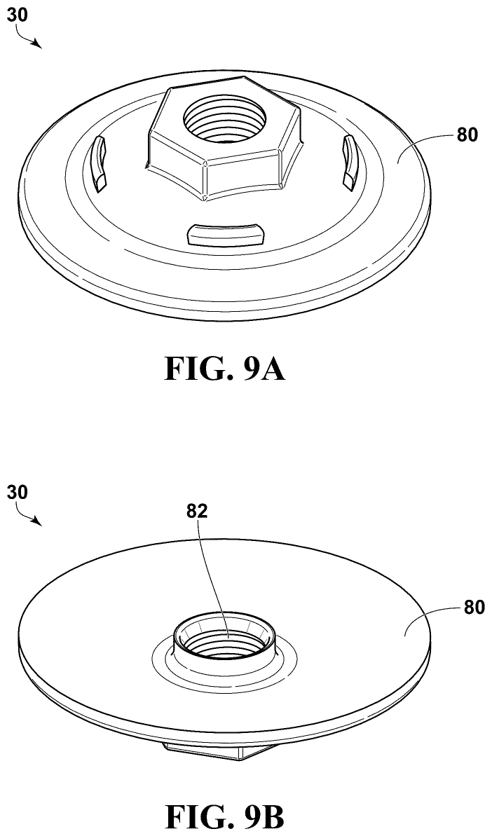

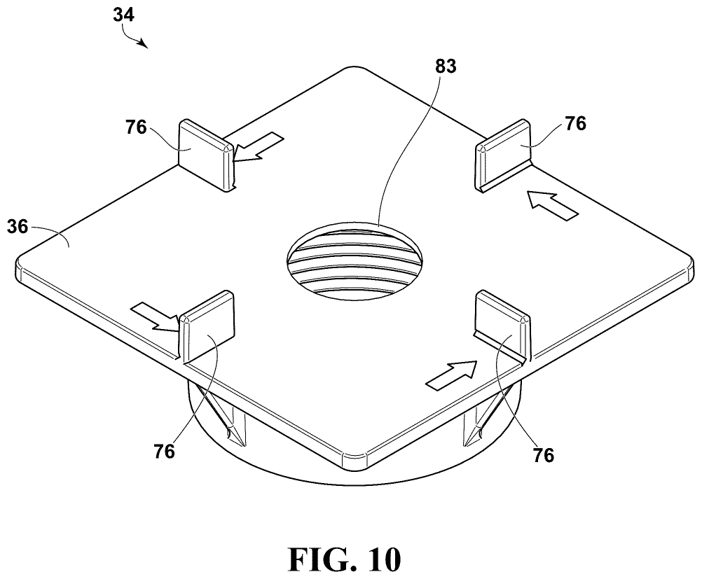

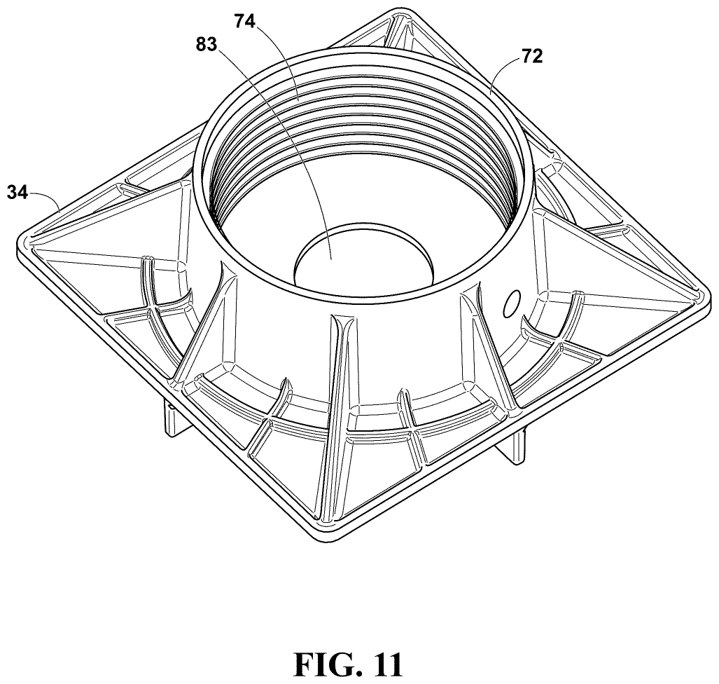

Referring to FIGS. 1 to 11, the present first embodiment of the invention, relates to an improved adjustable pedestal system 10 for level surfaces 12 and designed to facilitate the installation of surface materials in a level manner on varying slopes. This innovative system is designed to address the shortcomings of conventional pedestal systems, such as difficulty in installation, aesthetic issues, and insufficient functionality on uneven or high-wind surfaces.

The adjustable pedestal system 10 for level surfaces 12 includes a base member 14 having a bottom surface 16 and a top surface 18 with a convex dome member 20 formed thereon. A flexible, adjustable core member 22 may have a top end 24 and a bottom end 25 having a bottom surface 26. The bottom surface 26 may have a concave recess 28 may be adapted to friction fit with the top surface 18 of the convex dome 20 of the base member 14. The base member 14 may be more generally a planar body with the bottom surface 16 adapted to rest on a non-leveled substrate.

Slope compensation in this adjustable pedestal system 10 is achieved through the engagement between the integrated convex dome member 20 on the base member 14 and a concave recess 28 on the flexible, adjustable core member 22, allowing the adjustable pedestal system 10 to adjust to variations in slope. The adjustable pedestal system 10 also includes easily installable components and eliminates the need for exposed fasteners, thus improving aesthetics and functionality.

The adjustable pedestal system 10 also includes a securement assembly 30 which may be adapted to secure the base member 14 to the flexible, adjustable core member 22 in a position 32. A threaded post 42 is positioned at the central axis of the base member 14, extending upward from the convex dome 20. The threaded post 42 is adapted to receive a securement assembly 30 for fastening the flexible, adjustable core member 22.

Finally the adjustable pedestal system 10 may include a top member 34 having a top surface 36 may be adapted to receive and maintain level surfaces 12, and a bottom surface 38 that may be adapted to securely engage the flexible, adjustable core member 22, whereby the bottom surface 26 of the base member 14 engages a non-leveled surface, and the bottom surface 26 of the flexible, adjustable core member 22 may articulate the flexible, adjustable core member relative 22 to the top surface 18 of the convex dome 20 of the base member 14. This may accommodate the non-leveled surface and maintaining level surfaces 12 on the top member 34.

The base member 14 with the top surface 18 with a convex dome 20 formed thereon may be further defined as allowing for the cooperative engagement between the convex dome 20 of the base member 14 and the concave recess 28 of the flexible, adjustable core member 22, which then facilitates the articulation of the base member 14, thereby allowing it to adjust to variations in slope.

The base member 14 may be further defined as having an open, pattern 40 extending between the bottom and top surfaces 16 and 18 respectively. The open pattern 40, such as a lattice or grid of circular, oval, or polygonal apertures extending between the bottom and top surfaces 16 and 18 respectively. This open pattern 40 facilitates drainage, weight reduction, and the passage of mechanical fasteners (e.g., bolts, screws, or adhesives) for optional anchoring to the underlying surface The lattice 40 may have multiple circular holes 43 or apertures to facilitate the attachment of the base member 14 to a surface such as a slope. More specifically the lattice 40 can allow the passage of fastening mechanisms including bolts, adhesives and the like. By way of example only, the open pattern 40 may be defined as a regular array of holes, each with a diameter of 0.25-1.0 inches, spaced 0.5-2.0 inches apart, covering at least 30% of the base area. The open pattern 40 may be formed integrally during molding or machining and may be varied in shape and density to suit different installation requirements.

As noted above, the base member 14 may further comprise of the threaded post 42 positioned at a central point 44 of the base member 14 and extending towards the flexible, adjustable core member 22, and adapted to secure the flexible, adjustable core member 22 to the base member 14 with the engagement of the securement assembly 30.

The convex dome member of 20 the base member 14 is designed to engage with the flexible, adjustable core member 22 and specifically the bottom surface 26 with the concave recess 28 formed thereon. More specifically, the concave recess 28 of the bottom surface 26 of the flexible, adjustable core member 22 may further comprise of an enhanced coarse surface 48 for increased friction fit or engagement of the convex dome member 20 of the base member 14 to the flexible, adjustable core member 22. This built-in cooperative engagement between the convex dome member 20 and the concave recess 28 of the flexible, adjustable core member 22 facilitates articulation of the base member allowing it to adjust to variations in slope.

The texture of the enhanced coarse surface 48 provides increased grip and resistance, ensuring a secure and stable connection between the flexible, adjustable core member 22 and the base member 14. This frictional engagement is crucial for maintaining the desired angular orientation and stability of the pedestal system, especially on uneven surfaces. The interaction between the concave recess 28 of the flexible, adjustable core member 22 and the convex dome 20 of the base member 14 allows for slope compensation, enabling the adjustable pedestal system 10 to adjust seamlessly to variations in surface slope.

The concave recess 28 further aligns with the convex dome 20, facilitating an articulated movement that accommodates changes in slope while maintaining the structural integrity of the adjustable pedestal system 10. The flexible, adjustable core member 22 and base member's 14 cooperative engagement ensures that the adjustable pedestal system 10 can handle dynamic loads and environmental conditions, such as wind uplift, without compromising its performance or aesthetic appeal. The design of the flexible, adjustable core member 22 with its concave recess 28 and the texture of the enhanced coarse surface 48 is therefore integral to the overall functionality and reliability of the adjustable deck pedestal system 10.

The flexible, adjustable core member 22 may be an elongate, generally cylindrical or prismatic structure with the top end 202 and the bottom end 25 having the bottom surface 26 with the concave recess 28 shaped to mate with the convex dome 20 of the base member 14, allowing for multi-axial articulation.

The enhanced coarse surface 48 of the bottom surface 26 of the flexible, adjustable core member 22 may be 80 grit molded texture, knurled pattern, or embedded abrasive particles. This enhanced coarse surface 48 increases frictional engagement with the convex dome member 20, preventing slippage and maintaining the desired angular orientation under load. Alternative embodiments may use different grit sizes, raised ridges, or patterned projections to achieve similar frictional effects. This finish may be incorporated into adjustable pedestal system for level surfaces and specifically the concave recess during the manufacturing process namely the injection molding process, thereby creating a textured surface. The flexible, adjustable core member and the convex dome member 20 of the base member engage with each other, generating friction against the 80-grit surface, resulting in a stable connection.

The flexible, adjustable core member 22 may be further defined as including articulatable, flexing zones 60 down the length of the flexible, adjustable core member 22 which assist in the flexible, adjustable core member 22 adjusting to the desired angular orientation once there is engagement and alignment between the concave recess 26 and the convex dome member 20. More specifically the articulatable, flexing zones allow for adjustments along the length of the flexible, adjustable core member 22 by flexing or condensing allowing for changes in slope or non-level surfaces. Each flexing zone 60 may be defined by a circumferential groove 62, a thinned wall section 64, or an accordion-like bellows structure 66, formed from a resilient polymer or elastomeric material. These flexing zones 60 permit controlled bending and angular adjustment of the flexible, adjustable core member 22 relative to the base member 14, enabling the system to accommodate slopes up to 10 degrees in any direction.

The securement assembly 30 may be further defined as a threaded disc 80 or washer adapted to fasten the flexible, adjustable core member 22 to the base member 14. The threaded disc 80 is selectively engageable with the threaded post 42 of the base member 14 and the flexible, adjustable core member 22 and serves to secure these components together in a desired angular orientation. The threaded disc 80 features a threaded component 82 that fastens the flexible, adjustable core member 22 to the threaded post 42 of the base member 14 ensuring stable engagement while allowing for adjustments in angular orientation to accommodate sloped surfaces or non-leveled surfaces. The threaded disc 80 may be formed from metal or reinforced polymer, with internal threads matching the threaded post 42 of the base member 14. The threaded disc 80 is sized to fit within a recess at the bottom of the flexible, adjustable core member 22 and is rotatable to selectively engage or release the threaded post 42. When tightened, the threaded disc 80 clamps the flexible, adjustable core member 22 against the convex dome member 20, locking the flexible, adjustable core member 22 in the desired angular position. The securement assembly 30 may, by way of example only and not shown, may further include a locking ring, anti-rotation tabs, or a spring washer to prevent loosening under vibration or load. The disc may have knurled edges or tool engagement features (e.g., slots or holes) for manual or tool-assisted tightening.

The top end 24 of the flexible, adjustable core member 22 may be further defined as having a threaded top end 70 that is adapted to engage a bottom surface 72 of the top member 34 of the adjustable pedestal system 10 for level surfaces. The top end 24 of the flexible, adjustable core member 22 is externally threaded to engage a corresponding threaded collar 74 on the top member 34. More specifically the top member 34 may be secured to the flexible, adjustable core member 22 by engaging the respective threaded surfaces and tightening the top member 34 to the top end 24 of the flexible, adjustable core member 22. Multiple flexible, adjustable core members 22 may be used to accommodate varying slope gradients.

The bottom surface 72 of the top member 34 may be further defined as a bottom end having the threaded collar 74 for engagement with the threaded top end 70 of the flexible, adjustable core member 22. The top member 34 may generally be a planar plate with a top surface 36 adapted to support decking or surface materials for level surfaces 12 and the bottom surface 72 featuring the centrally located threaded collar 74. The threaded collar 74 is internally threaded to receive top end 24 of the flexible, adjustable core member 22, allowing for secure attachment and height adjustment.

The top surface 36 of the top member 34 may further include integral vertical tabs 76 by way of example for measured spacing of the level surfaces 12. More specifically the four integral vertical tabs 76 may be used to create equal space between decking or surface materials. The remainder of the top surface 36 of the top member 34 is a flat surface to support roof deck or surface materials. The top surface 36 may include four integral vertical tabs 76, spaced at 90-degree intervals around the periphery. Each integral vertical tab 76 may be 0.25-0.5 inches high and 0.125-0.25 inches thick, serving as spacers to maintain uniform gaps between adjacent decking panels or tiles. A central aperture 83 may be provided through the top member 34, and aligned with the threaded collar 74. The central aperture 83 provided through the top member 34 may receive a locking member 92.

The top surface 36 of the top member 34 may further include a dampening means 90 that may be adapted to engage the top surface 36. The dampening means 90 may be a pad comprising of ⅛″ thick rubber with a center hole and four side notches that may align with the four vertical tabs 76 to sit seamlessly on the top surface 36. The dampening means 90 provides sound absorption and friction to prevent roof deck or surface materials from moving laterally. The pad can be cut in half or quarters at the four side notches to be used to for final shimming during full pedestal system installation. The dampening means 90 may be formed from EPDM, neoprene, or similar weather-resistant materials. Alternative embodiments may use foam, cork, or composite laminates for enhanced acoustic or vibration performance.

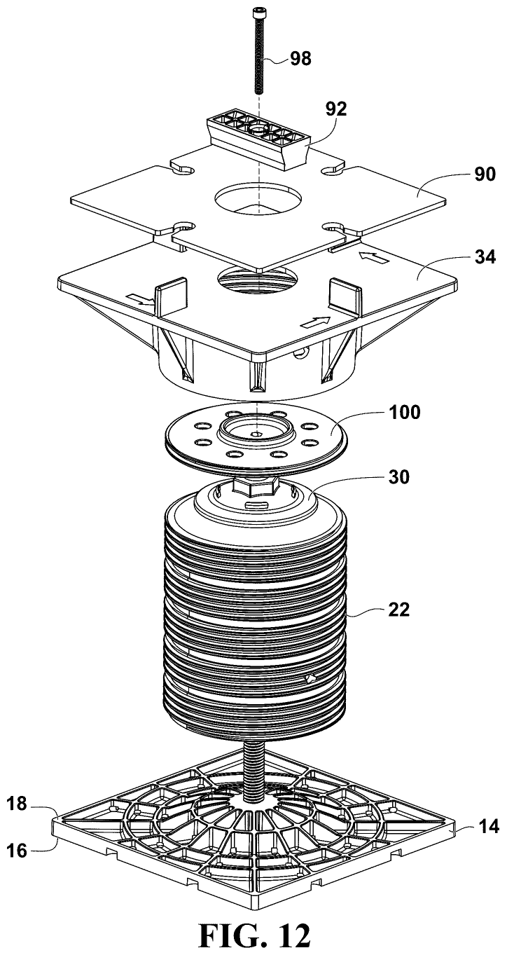

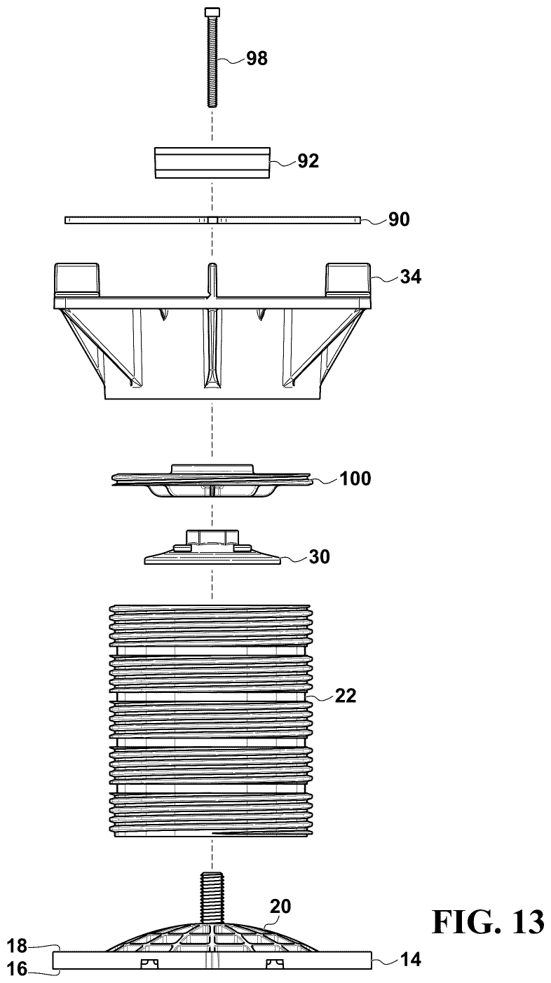

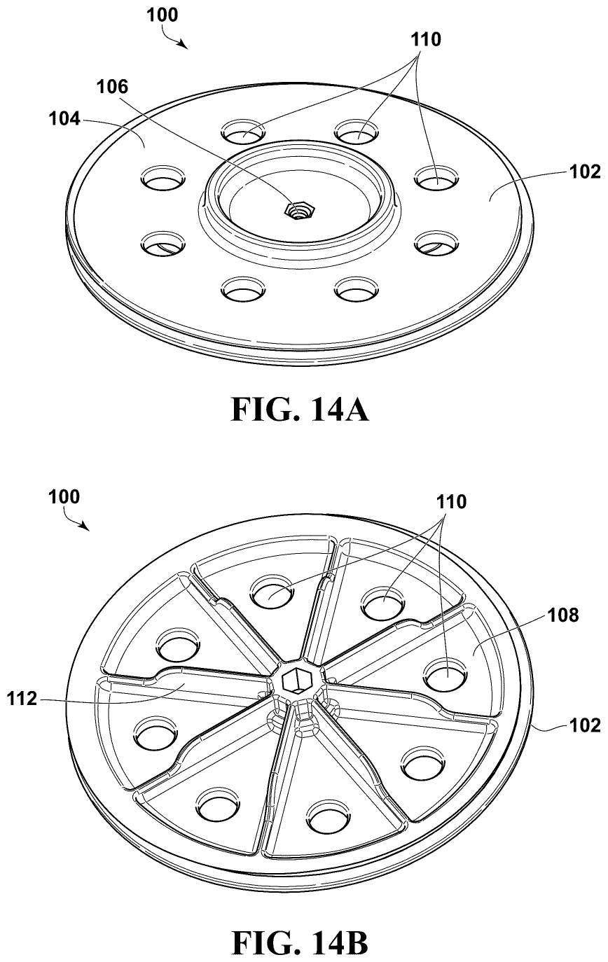

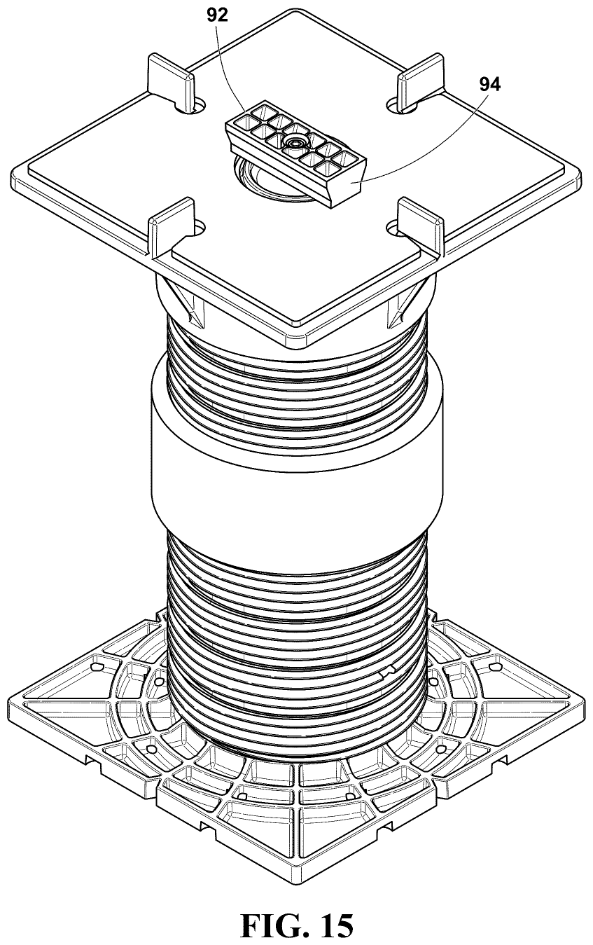

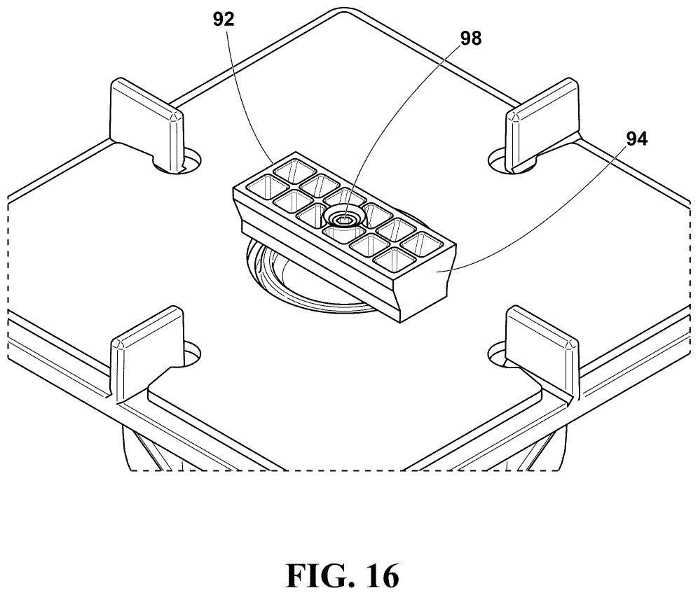

Referring to FIGS. 12 to 16, the second preferred embodiment specifically pertains to improved adjustable pedestal system 10 for level surfaces with a wind uplift restraint system 100 designed for supporting roof deck amenity surfaces, particularly on uneven surfaces or in areas prone to high winds. Conventional systems often require separate components to adjust the pedestal angle and to secure against wind uplift, which can complicate installation and detract from the roof deck's appearance. Additionally, these systems may utilize separate trays or exposed fasteners to secure the pedestals against wind uplift. These separate components can be complex to install and detract from the overall aesthetics of the roof deck.

There is a need for a roof deck pedestal system that is easy to install, adjustable for sloped surfaces, equipped with an invisible wind uplift restraint system 100. The adjustable pedestal system 10 for level surfaces with integrated wind uplift restraint of the present one embodiment offers several advantages over conventional systems, including simplified installation due to the elimination of separate components, improved aesthetics with the invisible wind uplift restraint mechanism, and enhanced functionality with the ability to accommodate sloped surfaces and provide wind resistance.

The adjustable pedestal system for level surfaces with the wind uplift restraint system 100 includes the same elements as describe above namely a base member 14 having a bottom surface 16 and top surface 18 with a convex dome 20 member formed thereon. A flexible, adjustable core member 22 may have the top end 24, and the bottom end 25 with a bottom surface 26. The bottom surface 26 may have a concave recess 28 may be adapted to friction fit with the convex dome 20 of the base member 14.

Slope compensation in this system is achieved through the engagement between the integrated convex dome 20 on the base member 14 and the concave recess 28 on the flexible, adjustable core member 22, allowing the system to adjust to variations in slope. A securement assembly 30 may be adapted to secure the base member 14 to the flexible, adjustable core member 22 in a position.

The wind uplift restraint system 100 may include a restraining means 102 that may have a top side 104 with a centered, threaded engagement aperture 106 and a bottom side 108. The restraining means 102 may further include at least two apertures 110 extending between the top and bottom sides 104 and 108 respectively. The bottom side 108 of the restraining means 102 may further include at least two vertically oriented fins 112. The restraining means 102 may be formed from metal or reinforced polymer, and the fins 112 may be 0.25-0.5 inches high, spaced 180 degrees apart. The apertures 110 may be used for drainage, fastener access, or alignment.

The top member 34 with a top surface 36 may be adapted to receive a portion of the top side 104 of the restraining means 102. The bottom surface 72 of the top member 34 may be adapted to accept the restraining means 102, as well as being adapted to securely engage the flexible, adjustable core member 22.

The adjustable pedestal system 10 for level surfaces may further include a locking member 92 for securing the top member 34 to the restraining means 102. The locking member 92 may be further defined as a lockdown bar 94 or washer depending on the application. This lockdown bar 94 provides a point of attachment for the wind uplift restraint mechanism 100 or restraining means 102 to the top member 34 that is secured to the flexible, adjustable core member 22. The lockdown bar 94 may be a rectangular or oval plate with tapered sides and a central hole for a threaded fastener. The lockdown bar 94 may be positioned above the restraining means 102 and secured by a screw or bolt 98 passing through the central hole and engaging the threaded aperture 106 of the restraining means 102. The washer alternative is a thin disc with a central hole, used when the lockdown bar 94 is not required. The locking member 92 may include anti-loosening features such as lock washers or thread-locking compounds.

More specifically, the restraining means 102 may be further defined as a puck or disc-shaped element with a center threaded insert 106 that extends through the top surface 36 of the top member 34. The puck is positioned on the underside 72 of the top member 34, hidden within the threaded collar of the bottom surface 74 of the top member 34. The lockdown bar 94 may secure the puck via the center threaded insert of the puck thereby engaging and securing the puck to the top member 34.

The lockdown bar 94 may further comprise of a rectangular-shaped element with tapered sides and center hole to allow for screw 98 to secure lockdown bar to puck. The top surface 36 can accept concrete pavers that include a profile or channel that engage the profile of the lockdown bar 94. More specifically the paver may include a channel positioned down the length of the paver's edge of at least one side of the paver. The channel on the edge of the paver may be positioned closest to the top surface 36 of the top member 34 and can accommodate tapered sides of the lockdown bar 94 whereby the channel of the paver partially surrounds the side of the lockdown bar 94. This allows for the engagement with the channel at the bottom edge of the concrete paver, and provides additional support to adjustable pedestal system 10 and the wind lift system 100, as the top edge of the paver is positioned above the lockdown bar 94. The lockdown bar 94 is adapted to engage with the top surface 104 of the puck which is engaged to the top end 24 of the flexible, adjustable core member 22. A fastener 98 such as a screw unit, for example a threaded fastener, may be used to secure the lockdown bar assembly in place.

Where the lockdown bar is not required, a thin disc-shaped plate with a hole in the center, such as a washer, may be used. The washer is typically used when the lockdown bar is omitted and other surface materials such as wood tiles and/or fiberglass grates and trays are used and require wind uplift restraint. The washer may be made of metal for example. The use of the lockdown bar or washer will vary based on application.

The adjustable pedestal system for level surfaces may further include at least one riser allowing for adjustable height of the adjustable pedal system The riser or stacker may have a variety of configurations depending on the requirement of the user. For example, the riser or stacker may be in the following configurations: 7″×7″×½″ or 1″ high stackable units, integral 3/16″ vertical spacers, and center insert compatible with wind uplift restraint system. Stackers can be layered to create desired heights in increments of ½″ and 1″ progressively. The risers are intended for lower height applications of the adjustable pedestal system for level surfaces. Risers may be formed from high-strength polymer, composite, or metal, and may include anti-slip surfaces or drainage channels. The risers are positioned between the base member and the core member, or between multiple core members, to achieve the desired installation height.

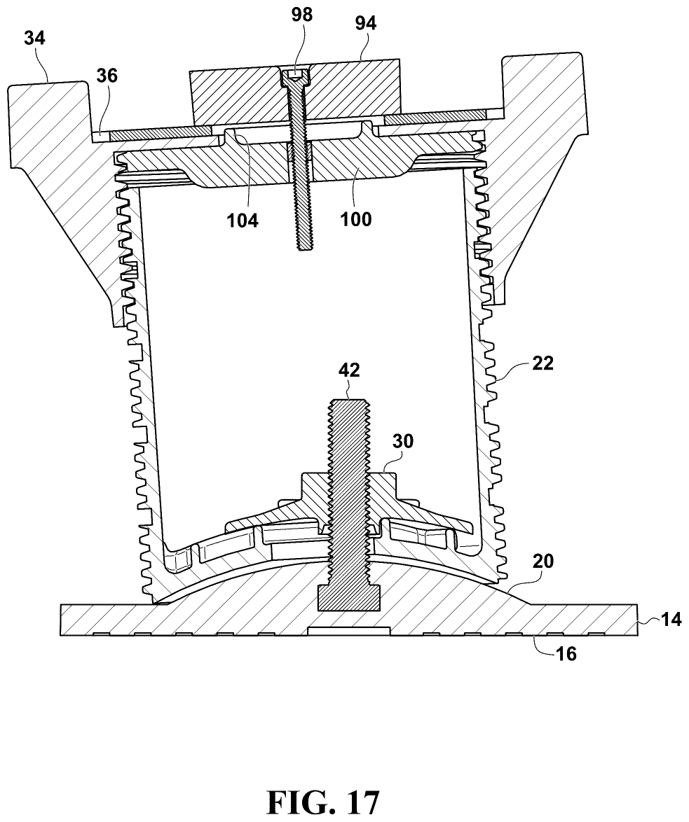

Referring to FIG. 17, in operation, the configuration of both the first and second embodiment have the bottom surface of the base member may engage a non-leveled surface, and the bottom surface of the flexible, adjustable core member may articulate the flexible, adjustable core member relative to the top surface of the convex dome of the base member. During installation, the base member is placed on the substrate, and the core member is positioned with its concave recess engaging the convex dome. The securement assembly is tightened to lock the desired angle. Risers are added as needed for height. The top member is threaded onto the core member, and the dampening pad is placed on top. The restraining means is inserted through the central aperture, and the locking means is secured to provide wind uplift resistance. This may accommodate the non-leveled surface and maintaining level surfaces on the top member. The articulation is maintained under load by the frictional engagement of the coarse surface and the clamping force of the securement assembly. The system is tested to support loads up to 1,000 lbs without loss of angular orientation.

The adjustable pedestal system for level surfaces with integrated wind uplift restraint of the present embodiments offers several advantages over conventional systems including simplified installation due to the elimination of separate components, improved aesthetics with the invisible wind uplift restraint mechanism, and enhanced functionality with the ability to accommodate sloped surfaces and provide wind resistance.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. The various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the such as; the term “example” is used to provide exemplary instances of the item in discussion, not an exhaustive or limiting list thereof; the terms “a” or “an” should be read as meaning “at least one,” “one or more” or the such as; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Hence, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other such as phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. An adjustable pedestal system for level surfaces, comprising:
a. a base member having a bottom surface and top surface with a convex dome member formed thereon;
b. a flexible, adjustable core member having a top end and a bottom surface having a concave recess adapted to friction fit with the top surface of the convex dome of the base member;
c. a securement assembly adapted to secure the base member to the flexible, adjustable core member in a position; and
d. a top member having a top surface adapted to receive and maintain level surfaces, and a bottom surface adapted to securely engage the flexible, adjustable core member, wherein the bottom surface of the base member engages a non-leveled surface, and the bottom surface of the flexible, adjustable core member articulates the flexible, adjustable core member relative to the top surface of the convex dome of the base member thereby accommodating the non-leveled surface and maintaining level surfaces on the top member.

2. The adjustable pedestal system for level surfaces as claimed in claim 1, wherein the concave recess of the bottom surface of the flexible, adjustable core member further comprises an enhanced coarse surface for increased friction fit of the convex dome of the base member to the flexible, adjustable core member.

3. The adjustable pedestal system for level surfaces as claimed in claim 1, wherein the base member further comprises an open, pattern extending between the bottom and top surfaces.

4. The adjustable pedestal system for level surfaces as claimed in claim 1, wherein the flexible, adjustable core member further comprises articulatable, flexing zones.

5. The adjustable pedestal system for level surfaces as claimed in claim 1, the base member further comprises a threaded post positioned at a central point of the base member and extending towards the flexible, adjustable core member, and adapted to secure the flexible, adjustable core member to the base member.

6. The adjustable pedestal system for level surfaces as claimed in claim 1, wherein the securement assembly further comprises a threaded disc for selectively engaging the threaded post to secure the flexible, adjustable core member to the base member in a desired angular orientation, wherein the cooperative engagement between the convex dome member of the base member and concave recess of the bottom surface of the flexible, adjustable core member facilitates articulation of the base member to accommodate variations in the non-leveled surface.

7. The adjustable pedestal system for level surfaces as claimed in claim 1, wherein the bottom surface of the top member further comprises a threaded collar for engagement with the top end of the flexible, adjustable core member.

8. The adjustable pedestal system for level surfaces as claimed in claim 1, wherein the top surface of the top member further comprises adapted four integral vertical tabs for measured spacing of the level surfaces.

9. The adjustable pedestal system for level surfaces as claimed in claim 1, further comprising a dampening means adapted to engage the top surface of the top member.

10. The adjustable pedestal system for level surfaces as claimed in claim 1, further comprising at least one riser allowing for adjustable height of the adjustable pedal system.

11. An adjustable pedestal system for level surfaces, comprising:
a. a base member having a bottom surface and top surface with a convex dome member formed thereon;
b. a flexible, adjustable core member having a top end and a bottom surface having a concave recess adapted to friction fit with the top surface of the convex dome of the base member;
c. a securement assembly adapted to secure the base member to the flexible, adjustable core member in a position;
d. a restraining means having a top side with a centered, threaded engagement aperture and a bottom side;
e. a top member having a top surface adapted to receive the restraining means and maintain level surfaces, and a bottom surface adapted to accept the restraining means and adapted to securely engage the flexible, adjustable core member; and
f. a locking means for securing the top member to the restraining means, wherein the bottom surface of the base member engages a non-leveled surface, and the bottom surface of the flexible, adjustable core member articulates the flexible, adjustable core member relative to the top surface of the convex dome of the base member thereby accommodating the non-leveled surface and maintaining level surfaces on the top member.

12. The adjustable pedestal system for level surfaces as claimed in claim 11, wherein the concave recess of the bottom surface of the flexible, adjustable core member further comprises an enhanced coarse surface for increased friction fit of the convex dome of the base member to the flexible, adjustable core member.

13. The adjustable pedestal system for level surfaces as claimed in claim 11, wherein the base member further comprises an open, pattern extending between the bottom and top surfaces.

14. The adjustable pedestal system for level surfaces as claimed in claim 11, wherein the flexible, adjustable core member further comprises articulatable, flexing zones.

15. The adjustable pedestal system for level surfaces as claimed in claim 11, the base member further comprises a threaded post positioned at a central point of the base member and extending towards the flexible, adjustable core member, and adapted to secure the flexible, adjustable core member to the base member.

16. The adjustable pedestal system for level surfaces as claimed in claim 11, wherein the securement assembly further comprises a threaded disc for selectively engaging a threaded post to secure the flexible, adjustable core member to the base member in a desired angular orientation, wherein the cooperative engagement between the convex dome member of the base member and concave recess of the bottom surface of the flexible, adjustable core member facilitates articulation of the base member to accommodate variations in the non-leveled surface.

17. The adjustable pedestal system for level surfaces as claimed in claim 11, wherein the bottom surface of the top member further comprises a threaded collar for engagement with the top end of the flexible, adjustable core member.

18. The adjustable pedestal system for level surfaces as claimed in claim 11, wherein the top surface of the top member further comprises adapted four integral vertical tabs for measured spacing of the level surfaces and a central aperture for receiving centered, threaded engagement aperture of the restraining means.

19. The adjustable pedestal system for level surfaces as claimed in claim 11, further comprising a dampening means adapted to engage the top surface of the top member and restraining means.

20. The adjustable pedestal system for level surfaces as claimed in claim 11, wherein the restraining means further comprises at least two apertures and the bottom side of the restraining means further comprises at least two fins.
